(19) United States
(12) Patent Application Publication
(10) Pub. No.: US 2006/0161331 A1
(43) Pub. Date: Jul. 20, 2006

(54) Drive control system for automotive vehicle

(75) Inventors: Hiroaki Kumon, Kariya-city (JP); Yukimasa Tamatsu, Okazaki-city (JP); Takashi Ogawa, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/326,905

(22) Filed: Jan. 6, 2006

(30) Foreign Application Priority Data
Jan. 14, 2005 (JP) 2005-008172

(51) Int. Cl. B62D 6/00

(52) U.S. Cl. 701/96; 701/70; 701/41

(57) ABSTRACT

In a drive control system, a front image taken by a camera is processed by an image processor, and an electronic control unit generates control target values according to outputs from the image processor. Actuators control a driving speed and/or a lateral position of an own vehicle in a driving lane, based on the control target values. Front obstacles, such as a preceding vehicle, a blind curve and an uphill road, are included in a front image, and a ratio of the front obstacle occupying a front vision field is calculated. The vehicle is controlled based on information including various obstacles located in front of the vehicle to thereby give an improved security to a driver.

### CROSS-REFERENCE TO RELATED APPLICATION

This application is based upon and claims benefit of priority of Japanese Patent Application No. 2005-8172 filed on Jan. 14, 2005, the content of which is incorporated herein by reference.

### BACKGROUND OF THE INVENTION

1. Field of the Invention

The present invention relates to a system for controlling drive of an automotive vehicle.

2. Description of Related Art

An automatic drive control system, which sets a distance between an own vehicle and a preceding vehicle to a longer distance when the preceding vehicle is a large vehicle, is proposed by JP-A-2-40798. This system includes two sonar detectors, i.e., one sonar detector that transmits ultrasonic waves toward a preceding vehicle with an upward angle and the other sonar detector that transmits ultrasonic waves in a horizontal direction. Distances to the preceding vehicle from an own vehicle detected by two sonar detectors are compared, and it is determined that the preceding vehicle is a large vehicle if the difference is smaller than a predetermined value. When the preceding vehicle is a large vehicle, the distance to the preceding vehicle is set to a longer distance, and the own vehicle follows the preceding vehicle not to change the set distance. Since a longer distance is kept between the own vehicle and the preceding large vehicle, it is avoided that a traffic signal is blinded by the preceding vehicle.

There are various objects other than the preceding vehicle that constitute obstacles located in front of the own vehicle. For example, a wall along a curved road that makes a blind curve or an uphill road will constitute a front obstacle. The drive control system disclosed in JP-A-2-40798 detects only a size of the preceding vehicle, and other front obstacles are not taken into consideration.

### SUMMARY OF THE INVENTION

The present invention has been made in view of the above-mentioned problem, and an object of the present invention is to provide an improved drive control system for an automobile, which detects front objects such as a wall along a curved road in addition to preceding vehicles and properly controls a vehicle to give improved security to a driver.

The drive control system for an automotive vehicle includes an image processor for processing a front image of an own vehicle, an electronic control unit for generating control target values, and actuators such as an acceleration (deceleration) actuator and a steering actuator. Obstacles, such as a preceding vehicle, a blind curve and an upward inclination of a road, located in a front vision field of a driver are taken in and processed by the image processor. The electronic control unit generates control target values based on the outputs from the image processor. The actuators control a driving speed of the vehicle and/or a lateral position in a driving lane based on the control target values fed from the electronic control unit.

The image processor outputs a vision field ratio sheltered by a front obstacle such as a preceding vehicle, a blind curve and an upward inclination of a road. A vision field ratio sheltered by a preceding vehicle (Rpv) is calculated by dividing a back side area of the preceding vehicle with a total area of the front vision field. A vision field ratio sheltered by a blind curve (Rbc) is calculated by dividing a difference between a normally visible distance and a calculated distance to a blind wall with the normally visible distance. A vision field ratio sheltered or hindered by an upward inclination of a road (Ri) is calculated by dividing a difference between a normally visible distance and a distance to a horizon of an uphill road with the normally visible distance. The front image may be taken in by an on-board camera. The vision field ratio sheltered by a preceding vehicle (Rpv) may be replaced by a back side area of the preceding vehicle, which is calculated from a front image taken by the camera.

According to the present invention, front obstacles other than a preceding vehicle can be detected. Since the driving speed and/or the lateral position in the driving lane is controlled based on the front vision field ratio sheltered by a front object (Rpv, Rbc, Ri), an improved security in driving can be given to the driver. The driver can have a proper front vision since a distance to the front obstacle and the lateral position of the own vehicle in a driving lane is controlled based on a size of the obstacle occupying the front vision of the driver.

Other objects and features of the present invention will become more readily apparent from a better understanding of the preferred embodiments described below with reference to the following drawings.

### BRIEF DESCRIPTION OF THE DRAWINGS

FIG. 1 is a block diagram showing an entire structure of a drive control system according to the present invention;

FIG. 2A is an illustration showing a front vision field in which a preceding vehicle is included;

FIG. 2B is a graph showing a target driving time (Tt) up to a preceding vehicle relative to a vision field ratio (Rpv) sheltered by a preceding vehicle;

FIG. 3A is an illustration showing a lateral position of a vehicle in a driving lane to obtain a better front vision when a preceding vehicle is located;

FIG. 3B is an illustration showing a lateral position of a vehicle in a driving lane to obtain a better front vision when a wall along a curved road is located;

FIG. 4 is a flowchart showing a process performed in an image processor;

FIG. 5 is a flowchart showing a process of detecting a preceding vehicle;

FIG. 6 is a flowchart showing a process of controlling a vehicle preformed in an electronic control unit (30) mounted on a vehicle;

FIG. 7 is a flowchart showing a process of generating control target values;

FIG. 8 is a graph showing a target driving time (Tt) up to a preceding vehicle relative to a backside area (Sb) of the preceding vehicle;

FIG. 9A is an illustration showing future positions of an own vehicle driving on a curved road;

FIG. 9B is an illustration showing a wall forming a blind curve;

FIG. 10 is a flowchart showing a process of detecting front objects performed in a second embodiment of the present invention;

FIG. 11 is a flowchart showing a process of generating control target values performed in the second embodiment of the present invention;

FIG. 12A is an illustration showing a normal vision range on a flat road;

FIG. 12B is an illustration showing a horizon of a uphill road close to the top of the hill; and

FIG. 12C is an illustration showing a wall along a curved road and a vehicle driving on the road.

### DETAILED DESCRIPTION OF THE PREFERRED EMBODIMENTS

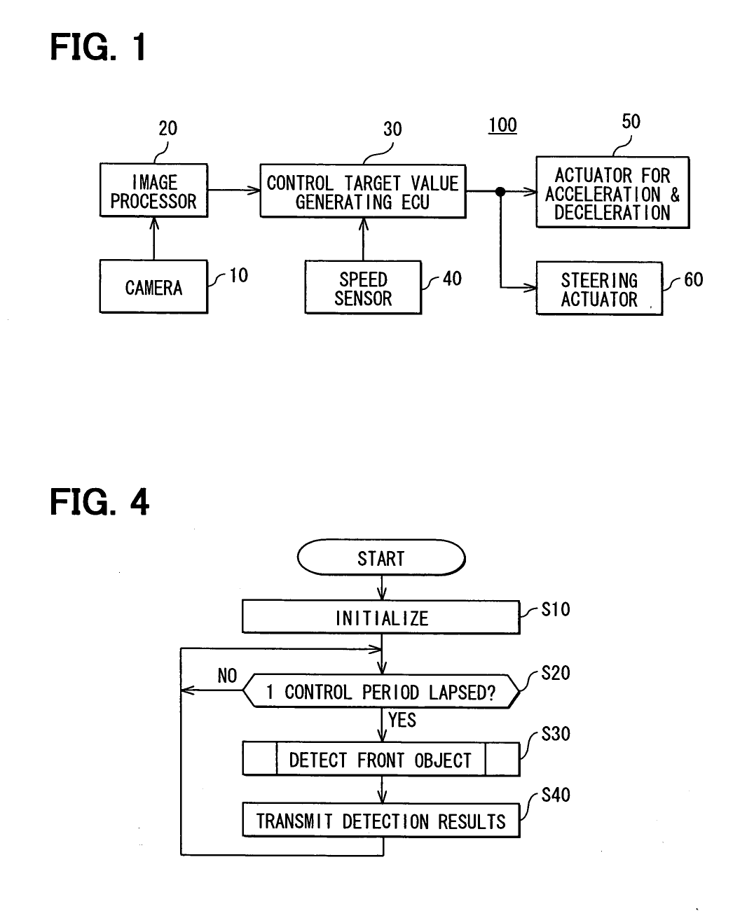

A first embodiment of the present invention will be described with reference to accompanying drawings. As shown in FIG. 1, a drive control system 100 is composed of an on-board camera 10, an image processor 20, an electronic control unit (ECU) 30 for generating target control values, a speed sensor 40 for detecting a driving speed of an own vehicle, an actuator 50 for controlling acceleration or deceleration, and a steering actuator 60.

The camera 10 is mounted on a front portion of a vehicle for taking images in front of the vehicle. The image processor 20 processes the images taken by the camera 10 to formulate information regarding front objects and own vehicle in a driving lane. The information is fed to the ECU 30 for generating the target control values. The ECU 30 is composed of a microcomputer that generates target control values to be fed the actuators 50, 60. That is, the ECU 30 sets a target driving time up to a preceding vehicle Tt (Tt=Dbet/Vown, where Dbet is a distance between the preceding vehicle and the own vehicle, and Vown is a driving speed of the own vehicle) when a preceding vehicle is detected. The vehicle speed Vown is controlled to attain the target driving time Tt. When no preceding vehicle is detected, the driving speed of the own vehicle Vown is controlled to attain a target driving speed Vt. The ECU 30 also generates target control values for the steering actuator 60.

The actuator 50 for acceleration and deceleration is composed of various actuators such as a throttle valve actuator, a brake actuator and a transmission actuator. Each actuator is controlled based on the target control values fed from the ECU 30. The steering actuator 60 includes a motor for driving a steering shaft. The motor is controlled based on the target control values fed from the ECU 30.

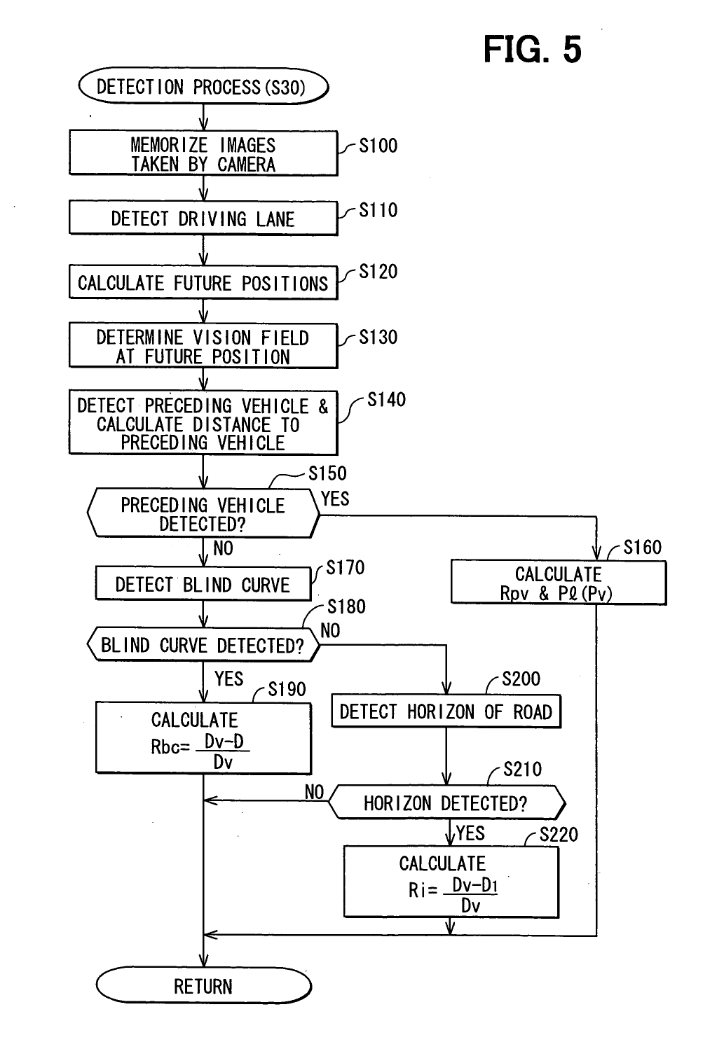

With reference to FIGS. 4 and 5, a process performed in the image processor 20 will be explained. At step S10 in FIG. 4, data stored in the image processor 20 are all cleared (initialized). At step S20, whether one control cycle period (e.g., 100 milliseconds) has lapsed is checked. If the one control cycle period has lapsed, the process proceeds to step S30, and if not, the process awaits lapse of the cycle time. At step S30, a process of detecting the front objects is carried out (details of which will be explained with reference to FIG. 5). At step S40, information regarding the front objects and the driving lane on which the own vehicle is driving is transmitted to the ECU 30.

The detection process performed in step S30 shown in FIG. 4 will be explained in detail with reference to FIG. 5. At step S100, the image data taken by the camera 10 are fed to the image processor 20 and memorized therein. At step S110, white lines defining a driving lane on which the own vehicle is driving are detected from the image data, and positions of the white lines, a shape of the driving lane, a width of the driving lane, a lateral position of the own vehicle in the driving lane Pl(own) are calculated. The shape of the driving lane may be estimated based on data from a steering sensor and a yaw rate sensor.

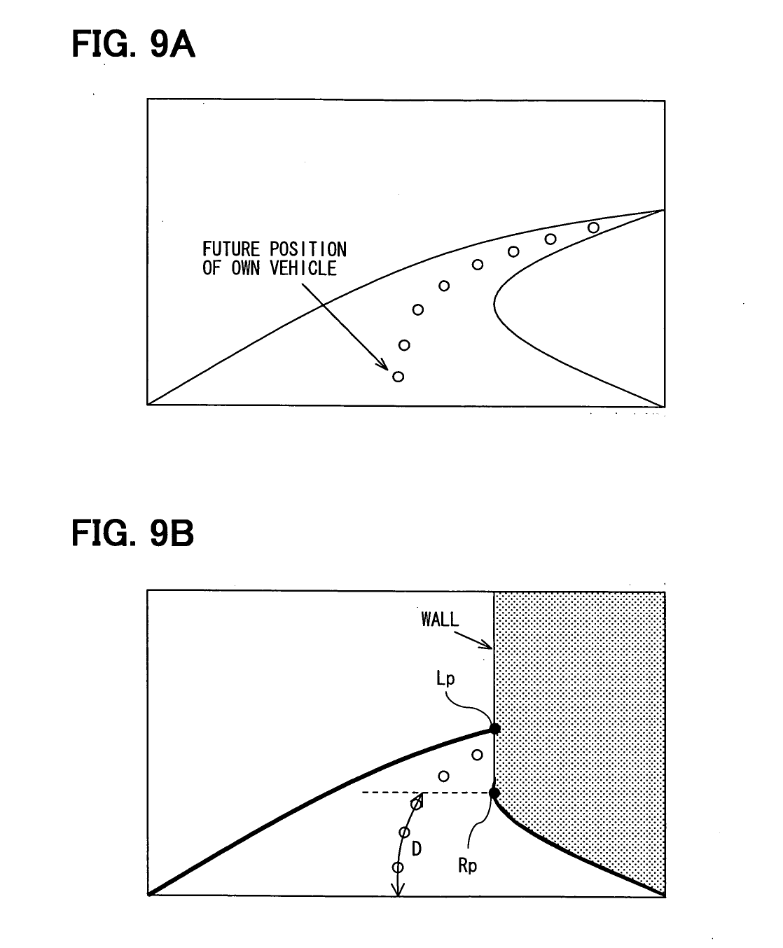

At step S120, future positions of the own vehicle is estimated from the information regarding the driving lane calculated at step S110, assuming that the own vehicle drives along the present driving lane, as shown in FIG. 9A. At step S130, a vision field at the future position of the own vehicle, in which front objects such as a wall forming a blind curve maybe located, is determined. At step S140, a preceding vehicle in the vision field determined in step S130 is detected from the front image by means of an edge abstracting method or a template matching method. When a preceding vehicle is detected, a distance from the own vehicle to the preceding vehicle is calculated from pixel locations of a bottom line of the preceding vehicle in the front image, assuming that the driving lane in front of the own vehicle is flat. The distance to the preceding vehicle may be obtained based on data from a radar or a stereo-camera (not shown). A vehicle driving further in front of the preceding vehicle may be included in the preceding vehicles.

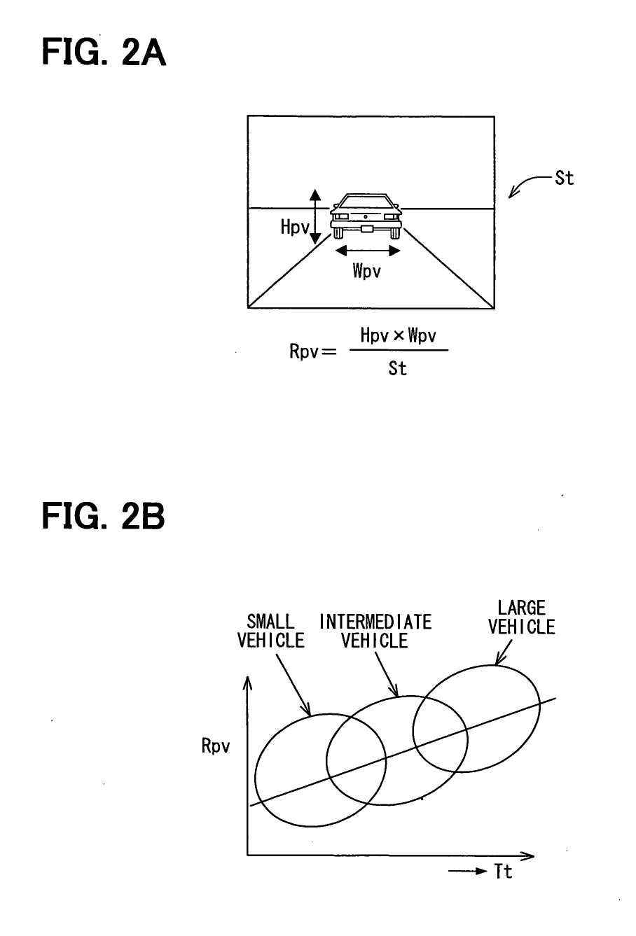

At step S150, whether or not the preceding vehicle is detected at the process of step S140 is determined. If the preceding vehicle is detected, the process proceeds to step S160, and if not, the process proceeds to step S170. At step S160, a vision field ratio Rpv sheltered by the preceding vehicle relative to a total vision field is calculated from the front image. Also a lateral position of the preceding vehicle Pl(pv) in the driving lane is calculated. All the information including Rpv, Pl(pv) and the distance to the preceding vehicle is fed to the ECU 30 as shown in step S40 in FIG. 4. The vision field ratio Rpv sheltered by the preceding vehicle relative to the total vision field St is calculated as shown in FIG. 2A. That is, a size of the preceding vehicle is obtained from its height Hpv and its width Wpv (Hpv×Wpv), and Rpv is calculated from a following formula: Rpv=(Hpv×Wpv)/St. Alternatively, Rpv may be obtained according to types of vehicles detected by analyzing the front image or based on information received via wireless communication with the preceding vehicle.

At step S170, a point up to which the present driving lane continues is determined, based on the information regarding the driving lane calculated at step S110 and the future positions of the own vehicle calculated at step S120. As shown in FIG. 9B, a point Rp, at an edge of a wall along a curved lane, where the right side white line becomes invisible, and a point Lp where the left side white line becomes invisible are abstracted from the front image. The edge of the wall along the curved road is also abstracted. At step S180, whether the edge of the wall forming a blind curve is detected or not is determined. If the edge of the wall forming the blind curve is detected, the process proceeds to step S190, and if not, the process proceeds to step S200.

At step S190, a distance D along an estimated driving path of the own vehicle from the present position to the point Rp (shown in FIG. 9B) where the right side white line becomes invisible is calculated. A vision field ratio Rbc sheltered by a blind curve is calculated according to the following formula: Rbc=(Dv−D)/Dv, where Dv is a normally visible range at a straight and flat lane.

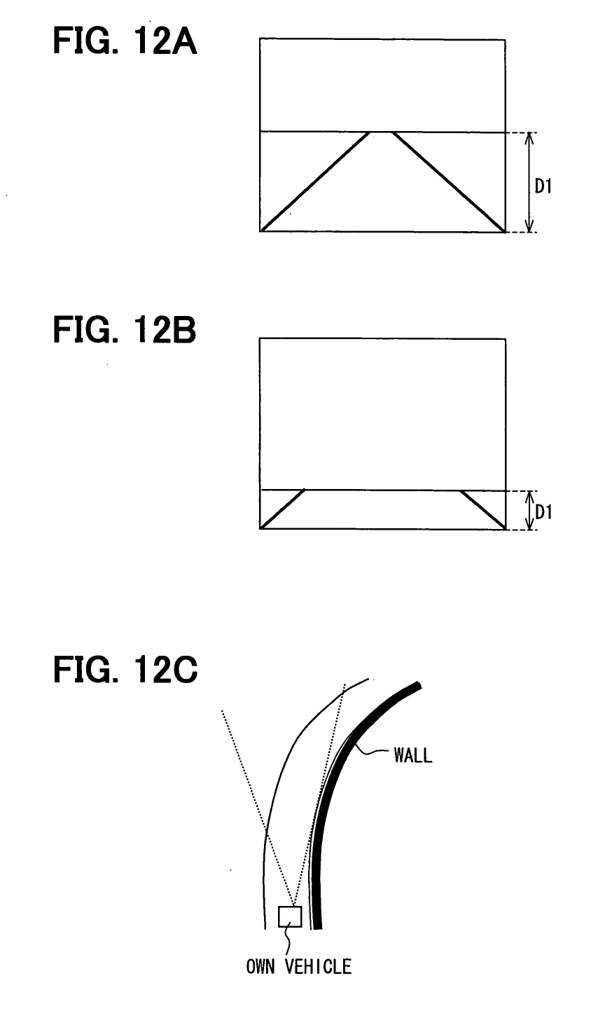

At step S200, whether the points Rp and Lp detected at step S170 are located close to a top of an uphill road (a top of a driving lane having an upward inclination) is determined. As shown in FIG. 12A, the white lines defining the lane extend to an upper portion in the front image when the driving lane is flat. A distance D1 is a distance to the upper end of the white lines in the front image. On the other hand, as shown in FIG. 12B, the white lines become invisible at a horizon of the road when the driving lane is an uphill road. That is the distance D1 in this case is much shorter than that of the flat road. Whether the own vehicle is close to the top of the uphill road or not can be determined based on the distance D1. At step S210, whether the horizon of the uphill road is detected or not is determined. If the horizon is detected, the process proceeds to the step S220, and if not, the process comes to the end (return).

At step S220, a vision field ratio Ri sheltered (or hindered) by an upward inclination is calculated according to the following formula: Ri=(Dv−D1)/Dv, where Dv is the normal visible range as explained above, and D1 is a distance to the horizon of the uphill road. All the information regarding the preceding vehicle including Rpv and all the information regarding the driving lane including Rbc and Ri are fed to the ECU 30 in the step S40 shown in FIG. 4.

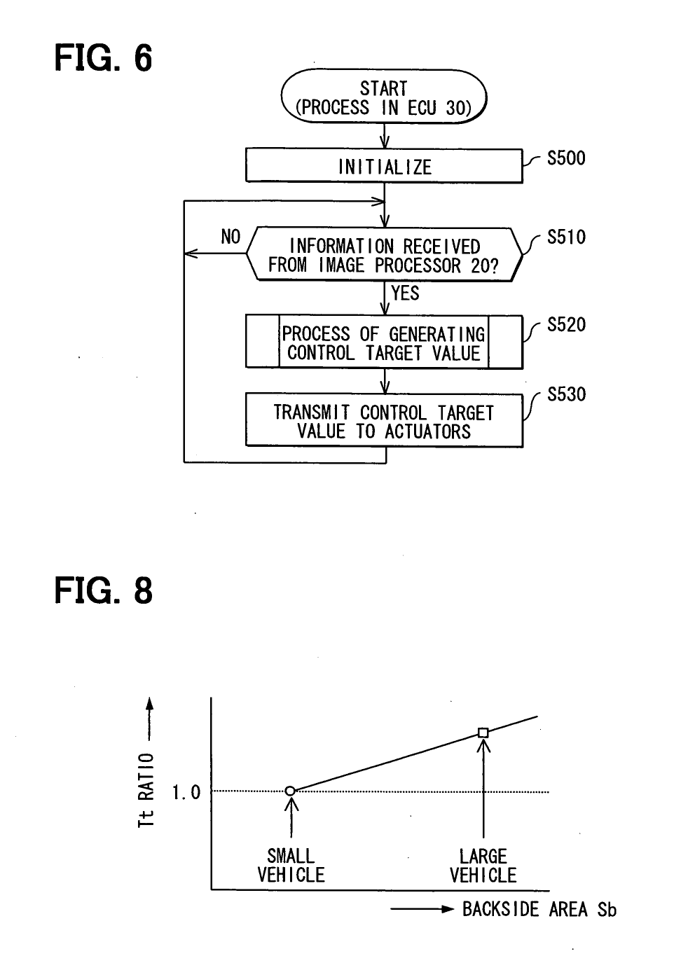

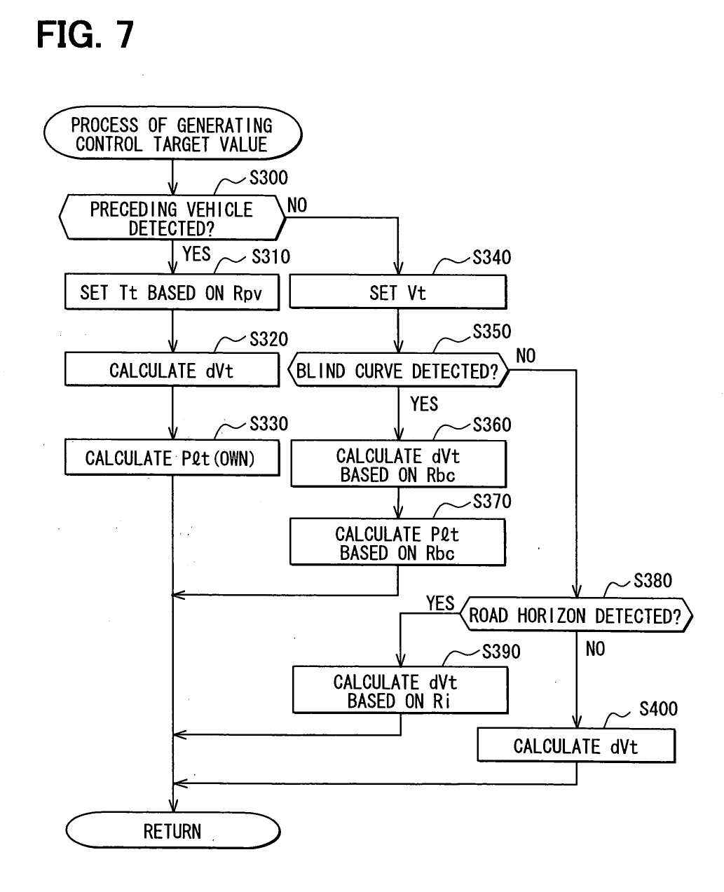

Now, a process performed in the control target value generating ECU 30 will be described with reference to FIGS. 6 and 7. At step S500 shown in FIG. 6, all the data stored in the ECU 30 are cleared (initialization). At step S510, whether or not all the information regarding the preceding vehicle and the driving lane outputted from the image processor 20 and data outputted from the speed sensor 40 are received are checked. If all the information and data are received, the process proceeds to step S520, and if not, the process stays there until the information and the data are received. At step S520, the control target values are generated, and at step S530, the generated control target values are transmitted to the actuators 50, 60.

With reference to FIG. 7, the process of generating control target values performed at step S520 shown in FIG. 6 will be explained in detail. At step S300, whether a preceding vehicle is detected or not is determined from the information received at step S510 (FIG. 6). If the preceding vehicle is detected, the process proceeds to step S310, and if not, the process proceeds to step S 340.

At step S310, a target driving time Tt up to the preceding vehicle (Tt=Dbet/Vown, where Dbet is a distance between the own vehicle and the preceding vehicle, and Vown is a driving speed of the own vehicle) is set according to the vision field ratio Rpv sheltered by the preceding vehicle. The target driving time Tt is set so that Tt becomes longer as the ratio Rpv is larger, as shown in FIG. 2B. This means that Tt is set longer when the preceding vehicle is larger since the ratio Rpv is larger when the preceding vehicle is larger. In this manner, a proper vision field of the driver is secured. At step S320, a target acceleration (or deceleration) dVt is calculated according to the target driving time Tt, taking into consideration the own vehicle speed Vown and the distance between the own vehicle and the preceding vehicle Dbet. The actuator 50 controls the driving speed of the own vehicle based on the dVt fed from the ECU 30.

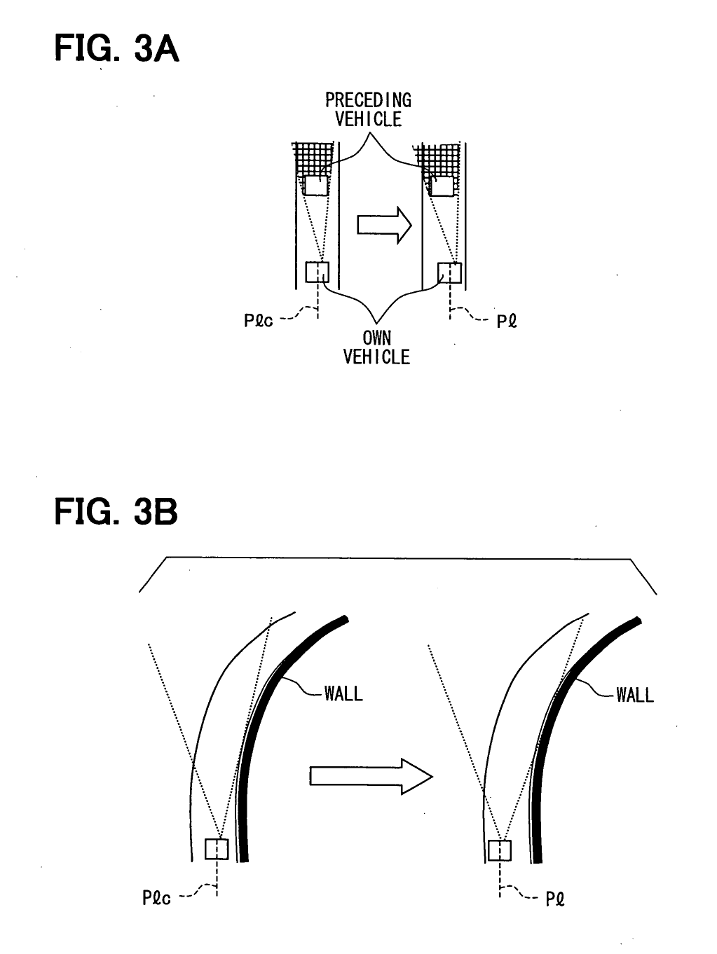

At step S330, a target lateral position Plt(own) of the own vehicle in the driving lane is calculated, based on the ratio Rpv, the lateral position Pl(pv) of the preceding vehicle in the driving lane and the lateral position Pl(own) of the own vehicle in the driving lane. The Plt(own) is calculated so that a good vision field of the driver is secured. More particularly, as shown in FIG. 3A, the own vehicle driving at a position Plc (a center of the driving lane) is shifted to a position Pl which is closer to the right side of the driving lane to secure a better vision field. An amount of the shift (or an amount of offset) becomes larger as the vision field ratio Rpv is higher. If the driver's seat is at the right side of the vehicle, the vehicle is shifted to the right side to secure a better vision field when driving in the straight lane. The steering actuator 60 controls the lateral position of the own vehicle in the driving lane according to the target lateral position Plt fed from the ECU 30.

At step S340 (where no preceding vehicle is detected), a target driving speed Vt is set. At step S350, whether or not the vision field ratio Rbc sheltered by a blind curve is included in the information regarding the driving lane, which is received at step S510 (FIG. 6), is checked. In other words, whether a blind curve is detected ahead of the vehicle is determined. If the blind curve is detected, the process proceeds to step S360, and if not, the process proceeds to step S380.

At step S360, a target acceleration (or deceleration) dVt is calculated based on the target driving speed Vt set at step S340, a present driving speed V and the vision field ratio Rbc, so that the driving speed does not exceeds the target driving speed Vt. The actuator 50 controls the driving speed based on the target acceleration (deceleration) dVt fed from the ECU 30. As shown in FIG. 12C, the driving speed is controlled not to exceed the target driving speed Vt when no preceding vehicle is found and a blind curve is detected ahead.

At step S370, a target lateral position Plt in the driving lane is calculated, based on the vision filed ratio Rbc (blind curve) and a present lateral position Pl so that a good vision field is secured for the driver. As shown in FIG. 3B, if the blind curve is found ahead when driving at the center of the lane Plc (in the left figure), the vehicle is shifted to the left side (in the right figure) to secure a better vision field for the driver. The steering actuator 60 controls the lateral position Pl according to the target lateral position Plt fed from the ECU 30. In the case where a curved driving lane is not blind as shown in FIG. 9A, the lateral position Pl is not shifted but it remains at the center of the lane Plc.

At step S380, whether or not the vision field ratio Ri sheltered (or hindered) by an upward inclination is included in the information fed at step S510 (FIG. 6) is determined. If the vision field ratio Ri (inclination) is included, the process proceeds to step S390, and if not, the process proceeds to step S400. At step S390, a target acceleration (deceleration) dVt is calculated, based on the target driving speed Vt set at step S340, a present driving speed V and the vision field ratio Ri (inclination), so that the driving speed of the own vehicle does not exceeds the target driving speed Vt. The actuator 50 controls the driving speed according to the target acceleration dVt fed from the ECU 30. This means that the driving speed is controlled not to exceeds the target driving speed Vt when the vehicle approaches a top of the uphill road, where a good vision field is not available.

On the other hand, at step S400 (where no upward inclination is found), a target acceleration (deceleration) dVt is calculated according to the target driving speed Vt set at step S340 and a present driving speed, so that the vehicle is driven at the target driving speed Vt. The actuator 50 controls the driving speed based on the target acceleration (deceleration) dVt fed from the ECU 30.

As described above, the drive control system 100 according to the present invention calculates the vision field ratio Rpv (preceding vehicle), the vision field ratio Rbc (blind curve) and the vision field ratio Ri (inclination). The driving speed and the lateral position of the own vehicle in the driving lane are controlled according to these vision field ratios Rpv, Rbc and Ri. In this manner, situations where the front vision field of the driver is sheltered or hindered are widely detected, and the driving speed and the lateral position in the driving lane are properly controlled according to the detected situations. Thus, the drive control system 100 of the present invention provides a driver with safety in driving, and the driver feels safety in driving.

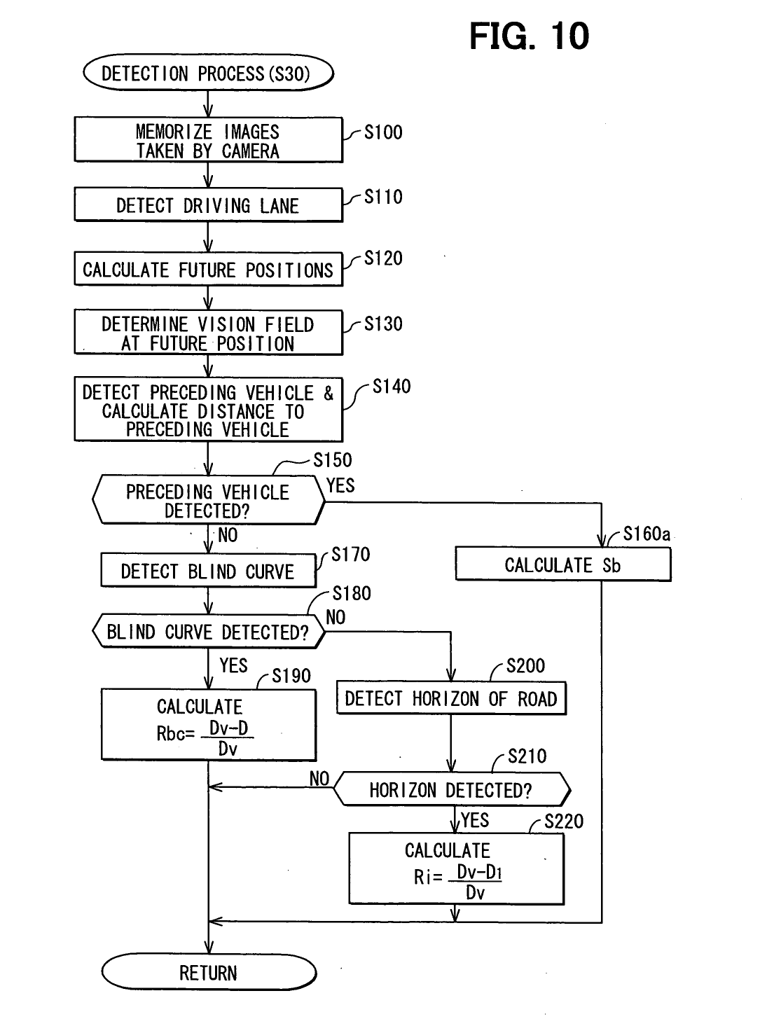

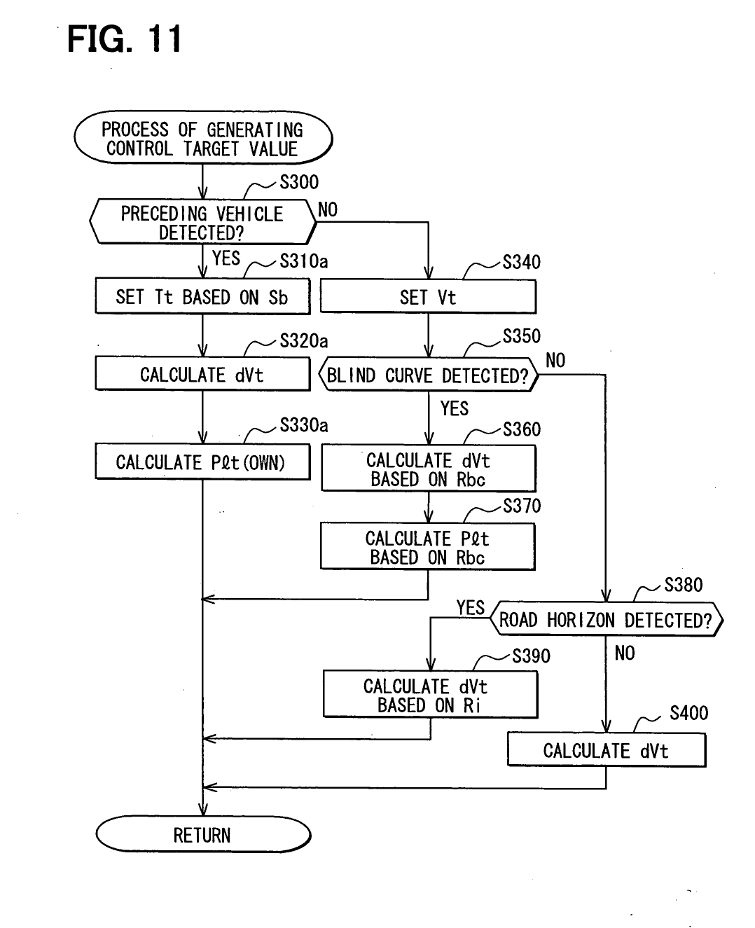

A second embodiment of the present invention will be described, referring mainly to FIGS. 10 and 11. The second embodiment is similar to the first embodiment, and differs only in the following point. In the second embodiment, a back side area Sb of a preceding vehicle is calculated from a front image taken by the camera 10 in place of the vision field ratio Rpv (preceding vehicle) calculated based on the front image. The target driving time Tt and the target lateral position Plt are set based on the vision field ratio Rpv in the first embodiment, while the Tt and the Plt are set based on the back side area Sb of a preceding vehicle in the second embodiment.

Therefore, FIG. 10 showing the process of detecting the front objects differs from FIG. 5 only in step S160a. FIG. 10 is the same as FIG. 5 in all other steps. FIG. 11 showing the process of generating control target values differs from FIG. 7 only in steps S310a, S320a and S330a. FIG. 11 is the same as FIG. 7 in all other steps. At step S160a in FIG. 10, the back side area Sb of the preceding vehicle is calculated from a front image taken by the camera 10. The distance Dbet between the own vehicle and the preceding vehicle, and the lateral position Pl(pv) of the preceding vehicle in the driving lane are also calculated at step S160a. All of these data, Sb, Dbet and Pl(pv) are fed to the ECU 30.

At step S310a in FIG. 11, a target driving time Tt (=Dbet/Vown as explained above) up to the preceding vehicle is calculated based on the back side area Sb of the preceding vehicle. The target driving time Tt is calculated according to a principle shown in FIG. 8. In FIG. 8, a Tt ratio is shown on the ordinate and the back side area Sb of a preceding vehicle is shown on the abscissa. The Tt ratio is 1.0 when the preceding vehicle is a small vehicle, and the Tt ratio becomes larger as a size of the preceding vehicle becomes bigger. In other words, the target driving time Tt is set to a longer time as the back side area Sb becomes larger. This means that the distance Dbet between the preceding vehicle and the own vehicle is set to a longer distance as the preceding vehicle is larger.

At step S320a, a target acceleration (deceleration) dVt is calculated based on the target driving time Tt, taking into consideration a present driving speed and the distance Dbet between the own vehicle and the preceding vehicle. The actuator 50 controls the driving speed based on the target acceleration (deceleration) dVt. At step S330a, a target lateral position Plt(own) of the own vehicle in the driving lane is calculated, based on the back side area Sb of the preceding vehicle, a lateral position Pl(pv)of the preceding vehicle in the driving lane and a present lateral position Pl(own) of the own vehicle in the driving lane, so that a better vision field is secured for the driver. More particularly, as shown in FIG. 3A, the own vehicle taking the central position Plc (the left drawing) is laterally shifted to the right side Pl (the right drawing). The amount of the lateral shift is set to become larger as the back side area Sb of the preceding vehicle becomes larger.

The vehicle control system 100 as the second embodiment of the present invention controls the driving speed and the lateral position in the driving lane based on the back side area of a preceding vehicle. Since the vision field of a driver is more hindered as the size of the preceding vehicle is larger, the driving speed and the lateral position are controlled according to the back side area Sb of the preceding vehicle. A proper vision field of a driver is secured, and accordingly the driver feels safely in driving.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A drive control system for an automotive vehicle, comprising:
first means for obtaining a vision field ratio sheltered by an object in front of an own vehicle relative to a total vision field; and
means for controlling at least either one of a driving speed of the own vehicle and a lateral position of the own vehicle in a driving lane based on the vision field ratio.

2. The drive control system as in claim 1, further including a camera for taking an image in front of the own vehicle, wherein:
the first means obtains the vision filed ratio based on the image taken by the camera.

3. The drive control system as in claim 2, wherein:
the vision field ratio obtained by the first means is a vision field ratio sheltered by a preceding vehicle relative to a total vision field taken by the camera.

4. The drive control system as in claim 2, wherein:
the vision field ratio obtained by the first means is a vision field ratio sheltered by an obstacle located in front of a curved road on which the own vehicle is driving, the vision field ratio being calculated by dividing a difference between a normally visible range and a distance from the own vehicle to the obstacle, which is calculated based on the image taken by the camera, with the normally visible range.

5. The drive control system as in claim 2, wherein:
the vision field ratio obtained by the first means is a vision field ratio sheltered by an upward inclination of a road on which the own vehicle is driving, the vision field ratio being calculated by dividing a difference between a normally visible range and a distance from the own vehicle to a road horizon with the normally visible range.

6. The drive control system as in claim 3, wherein:
the controlling means includes means for setting a target driving time up to the preceding vehicle and controls a driving speed of the own vehicle to realize the target driving time.

7. The drive control system as in claim 3, wherein:
the controlling means controls a lateral position of the own vehicle in a driving lane relative to a lateral position of the preceding vehicle on the same driving lane, based on the vision field ratio sheltered by the preceding vehicle.

8. The drive control system as in claim 4, wherein:
the controlling means controls a driving speed of the own vehicle not to exceed a predetermined target speed and/or a lateral position of the own vehicle in a driving lane relative to a lateral position of the preceding vehicle in the same driving lane, based on the vision field ratio sheltered by the obstacle located in front of the curved road.

9. The drive control system as in claim 5, wherein:
the controlling means controls a driving speed of the own vehicle not to exceed a predetermined target speed, based on the vision field ratio sheltered by the upward inclination of the road.

10. A drive control system for an automotive vehicle, comprising:
a second means for obtaining a back side area of a preceding vehicle; and
means for controlling at least either one of a driving speed of the own vehicle and a lateral position of the own vehicle in a driving lane, based on the back side area of the preceding vehicle.

11. The drive control system as in claim 10, further including a camera for taking an image of a back side of the preceding vehicle, wherein:
the second means calculates the back side area based on the image taken by the camera.

12. The drive control system as in claim 10, wherein:
the controlling means includes means for setting a target driving time up to the preceding vehicle and controls a driving speed of the own vehicle to realize the target driving time.

13. The drive control system as in claim 10, wherein:
the controlling means controls a lateral position of the own vehicle in a driving lane relative to a lateral position of the preceding vehicle in the same driving lane, based on the back side area of the preceding vehicle.
